(19) United States
(12) Patent Application Publication
(10) Pub. No.: US 2004/0148568 A1
(43) Pub. Date: Jul. 29, 2004

(54) Checker and fixer algorithms for accessibility standards

(76) Inventor: Timothy Stephen Springer, San Francisco, CA (US)

Correspondence Address: FISH & RICHARDSON PC, 225 FRANKLIN ST, BOSTON, MA, 02110, US

(21) Appl. No.: 10/013,886

(22) Filed: Oct. 19, 2001

Related U.S. Application Data
(60) Provisional application No. 60/297,994, filed on Jun. 13, 2001.

(51) Int. Cl. G06F 17/00

(52) U.S. Cl. 715/513

(57) ABSTRACT

A method, apparatus and computer program product residing on a computer readable medium are described. The method, apparatus and computer program may use checkers to check a data model of a web page for accessibility, for example compliance with web accessibility requirements codified in 36 CFR § 1194.22. The method, apparatus and computer program may also implement fixers to modify HTML code to ensure compliance with 36 CFR § 1194.22. The method, apparatus and computer program may implement tolerances to allow personalization of checkers.

### CLAIM OF PRIORITY

This application claims priority under 35 USC § 119(e) to U.S. patent application Ser. No. 60/297,994, filed on Jun. 13, 2001, the entire contents of which are hereby incorporated by reference.

### COMPUTER PROGRAM LISTING APPENDIX

This application includes a computer program listing appendix in accordance with 37 CFR § 1.96(c), the entire contents of which are hereby incorporated by reference. One compact disk is submitted, with files: configuration.xml, 11 KB, Oct. 19, 2001; FormLabelFixerjava, 22KB, Oct. 19, 2001; LinkSkipCheckerjava, 14KB, Oct. 19, 2001; LinkSkipFixerjava, 14KB, Oct. 19, 2001; and NonVisualTextFilterjava, 2kb, Oct. 19, 2001.

### BACKGROUND

This invention relates to verifying compliance with Section 508 accessibility standards and automatically retrofitting the HTML of web pages to ensure compliance.

The Architectural and Transportation Barriers Compliance Board (Access Board) has issued accessibility standards for electronic and information technology covered by Section 508 of the Rehabilitation Act of 1973, as amended by the Workforce Investment Act of 1998. The standards set forth a definition of electronic and information technology and the technical and functional performance criteria necessary for technology to comply with Section 508. As explained at http://www.access-board.gov/sec508/508standards.htm, “Section 508 requires that when Federal agencies develop, procure, maintain, or use electronic and information technology, they shall ensure that the electronic and information technology allows Federal employees with disabilities to have access to and use of information and data that is comparable to the access to and use of information and data by Federal employees who are not individuals with disabilities, unless an undue burden would be imposed on the agency. Section 508 also requires that individuals with disabilities, who are members of the public seeking information or services from a Federal agency, have access to and use of information and data that is comparable to that provided to the public who are not individuals with disabilities, unless an undue burden would be imposed on the agency.”

The Section 508 standards cover various products including “web-based intranet and internet information and applications.” 36 CFR § 1194.22. Section 1194.22 sets standards for web accessibility, including web accessibility for assistive technologies. (With regard to web accessibility, assistive technology generally refers to software that enables an individual with a certain disability to interact with a computer. For example a sight-impaired individual may be unable to see the screen of a computer and may need the assistance of a screen reader to interact with a computer. A screen reader is assistive technology that reads the contents of a computer screen to the user.) These standards are based in part on the World Wide Web Consortiums' (W3C) Web Accessibility Initiative's (WAI) Web Content Accessibility Guidelines 1.0 (WCAG 1.0), as well as other agency documents on web accessibility and additional recommendations of the Electronic and Information Technology Access Advisory Committee (EITAAC).

Because the award of government contracts is based in part on compliance with the Section 508 standards, it is prudent for web service providers to find a cost-efficient and effective means for implementing those standards.

### SUMMARY

In one aspect, the invention provides a method and computer program product for checking an HTML document of a web page for compliance with Section 508 of the Rehabilitation Act of 1973. In another aspect, the invention provides a method for fixing and/or checking an HTML document for accessibility. The method may include, and the computer program product may implement, the steps of running a checker against an HTML document; flagging a violation of a requirement of Section 508; and fixing a section of the HTML document containing the flagged violation by modifying HTML code. In one aspect, the method may include, and the computer program product may implement, the steps of providing a user interface operable to display information about the flagged violation and query a user for input relating to the flagged violation; receiving the user input; and, using the user input, fixing the section of the HTML document. In another aspect, the method may include, and the computer program product may implement, the step of offering a recommended solution to the user and/or the step of using previously-saved user input saved at the user's request to fix the section of the HTML document. In one aspect, fixing the section of the HTML document containing the flagged violation is accomplished without input from a user.

In another aspect of the invention, the method may include, and the computer program product may implement, the step of providing a user interface operable to display information about the flagged violation and provide details as to how the violation may be manually cured and/or the step of displaying the flagged violation on a user interface. In another aspect, the method may include, and the computer program product may implement, the steps of providing a user interface operable to accept user input; and, using the user input, modifying tolerances of one or more checkers. In another aspect, the method may include, and the computer program product may implement, the steps of locating logical groups of links in the document; and determining whether there is a facility for skipping past a located, logical group of links. In one aspect, locating logical groups of links in the document may include producing a psuedo-model of a document that represents the document as a series of text and links; dividing the pseudo-model into groups of links that are separated by a predetermined length of text; and dividing each group based on ancestral differences between adjacent links. In one aspect, determining whether there is a facility for skipping past a located, logical group of links may include checking for inner-document links within each logical group of links that allow a user to skip past the logical group of links.

In another aspect of the invention, the method may include, and the computer program product may implement, the step of inserting an inner-document link permitting a user to skip past a group of links. In another aspect, the method may include, and the computer program product may implement, the steps of identifying a located, logical group of links for which there is no facility for skipping past; searching elements near the front of the identified link group for a surrogate anchor element; and inserting an inner-document link at the beginning of the link group, where the inner-document link inserted at the beginning of the link group replaces the surrogate anchor element. In another aspect, the method may include, and the computer program product may implement, the steps of identifying, for a form field not associated with a label, a piece of text that is a candidate for the label; and associating the piece of text with the label. In another aspect, the method may include, and the computer program product may implement, the steps of identifying, for a form field not associated with a label, a piece of text that is a candidate for the label; prompting a user to select the candidate label or insert a label; and, based on the user's selection, associating the piece of text with the candidate label or the inserted label. In one aspect, identifying a piece of text that is a candidate for the label may include identifying a piece of text that is not a child of any of “a”, “applet”, “script”, “noscript”, “select”, “object”, “head”, or “label;” and has a predetermined text length.

Aspects of the invention can include one or more of the following advantages. A compliance retrofitter in accordance with the invention can be used to scan the HyperText Mark-up Language (HTML) code that powers the web, identify violations with Section 508 Standards (checkers), and correct those violations by inserting the necessary corrections into the code in real time (fixers). Incorporation into the system of “tolerances” allows the checkers to be customized to individual clients and greatly enhances the value of such tools when distributed on an organization-wide level.

### DESCRIPTION OF DRAWINGS

FIG. 1 is an exemplary screen shot used to implement the compliance retrofitter.

FIG. 2 is an exemplary screen shot used to implement tolerances in the compliance retrofitter.

Like reference symbols in the various drawings indicate like elements.

### DETAILED DESCRIPTION

### A. Compliance Checking and Retrofitting Algorithms—Checkers and Fixers

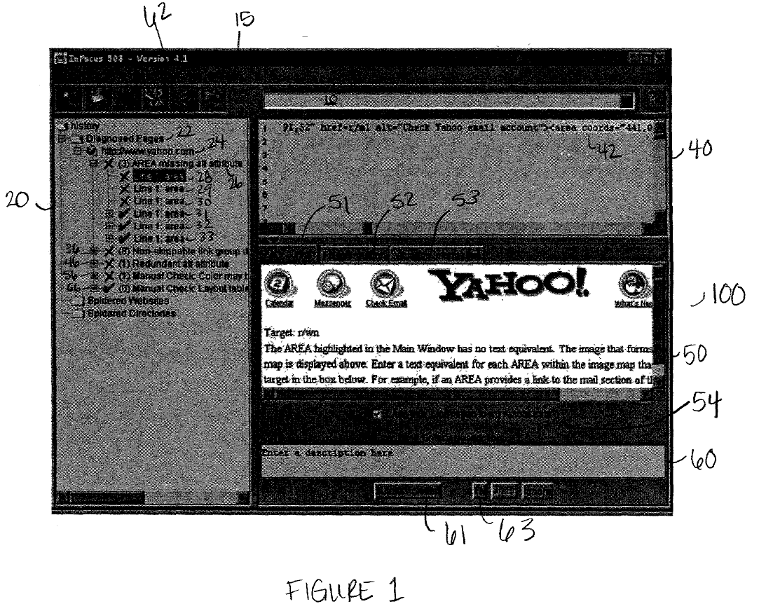

Referring to FIG. 1, a compliance retrofitter employing an algorithm designed to check for and/or fix violations of 36 CFR § 1194.22 may produce a graphical user interface GUI, for example a GUI displaying screen shot 100. A user may check compliance of a document, i.e., a particular web page or file, by entering a URL into the navigation bar 10 or by clicking on the file icon 15 and selecting a URL or entire file. The compliance retrofitter will operate on the HTML of the document and will check compliance with one or more paragraphs of § 1194.22, listed below in Table I(a), by implementing one or more “checkers” and, depending on the paragraph of § 1194.22, by requiring some form of directed manual review. The checkers implemented by the compliance retrofitter are sets of tests that are run against documents, for example files or web pages, to analyze compliance with a standard, e.g., Section 508. A list of exemplary checkers and their functionalities is provided in Table I(b).

One of the checkers ran in the creation of screen shot 100 was the ImageMapChecker, which checked compliance of the web page www.yahoo.com with paragraphs (a) and (f) of § 1194.22. As noted in the sixth row of Table I(b), ImageMapChecker, in part, checked the HTML code of www.yahoo.com to determine if all of the AREAS had valid “alt attributes,” i.e., to determine if each AREA had associated with it an alternative textual description. (An AREA element defines a part of an image that functions as a link. Since some users do not use browsers that display images, having valid alt attributes for AREAs allows these users to navigate through the page.) Referring back to FIG. 1, the results created by running the checkers are presented in tree format in the history window 20. As seen in this example, under the folder “Diagnosed Pages” 22, the first analyzed page is displayed —www.yahoo.com 24. Under the page www.yahoo.com 24 are the violations 26, 36, 46, 56, and 66 that were found, for example (3) AREA missing alt attribute 26, as well as instances Line 1: area(s) 28-33 (where instances are violations within violations). The instances Line 1: area(s) 28-33 indicate that the compliance checker algorithm found six HTML elements that were missing alt attribute.

An HTML window 40 provides the HTML code for the currently selected document (www.yahoo.com 24), and highlights the currently selected instance, in this case Line 1: area 28. Below HTML window 40 is fixer window 50 that displays information related to fixers, or algorithms that make changes to HTML documents or other documents to bring the documents into compliance with the standard, e.g., § 1194.22. A list of § 1194.22 fixers are listed in Table II(a) along with the relevant standard and manual fixes (if any). The functionality of each fixer is explained in Table II(b). As can be seen, the ImageMapFixer adds alt attributes to AREA elements that currently do not have valid alt attributes.

Referring again to FIG. 1, fixer window 50 has three selectable pages—fix violation 51, fix information 52, and violation information 53. Fix violation page 51 is the graphical display for a fixer, showing the fix for the currently selected instance Line 1: area 28. The fix violation page 51 displays a description of the violation as well as instructions as to the change that needs to be implemented to cure the violation. The instructions may explain a fully automatic change that will be implemented or may explain a change that will require user input (interactive change). The fix information page 52 provides information about how the fixer will make a change to the HTML and what that change will look like. The violation information page 53 provides a description of the violation. A user can implement a fix by clicking on the fix button 63.

Also provided is the option: “Add this information to my Autofix data” 54. If the user checks the box corresponding to this option, an insertion is made into an Autofix library for later reference by the compliance retrofitter. Selecting the Autofix Violation button 61 will apply the corrections contained in the Autofix library to the current violation. A user can fix multiple pages by selecting the “Autofix” icon 62 next to the Menu Bar. Certain violations, when fixed using the standard fix button 63, will add fix information to the Autofix library if the “Add this information to my Autofix data” 54 is checked. This allows a user to build up a store of fixes to be applied to other documents.

Located beneath the fixer window 50 is description window 60. The description window 60 is used to solicit user input, in this case a description of the non-textual element.

Once a violation has been fixed, the instance 28-33 or violation 26, 36, 46, 56, or 66 is marked with a checkmark as seen in the history window 20. Violations that have not yet been fixed are marked with an “x” mark.

The fix violation page 51 is displayed only when the compliance retrofitter is designed to run in an interactive fix mode—the page displays information about fixes for the current instance and solicits user input for the interactive fix. Alternatively, the compliance retrofitter may operate in an autofix mode in which there is no screen display and only automatic fixes—those not requiring user input—are implemented. And, in some cases, the compliance retrofitter may not be designed to fix every violation. In such a case, the screen shot 100 will not display fixer information in fixer window 50, but instead may provide details as to how the violation can be manually cured.

TABLE I(a)
36 CFR § 1194.22 Checkers

| 36 CFR § | | | |
|---|---|---|---|
| 1194.22 | | | |
| Paragraph | Description | Checker | Manual Review |
| A | Paragraph (a) requires that a | ImageChecker | No Manual |
| | text equivalent for every non- | ObjectTextChecker | Review Required |
| | text element shall be provided. | ImageMapChecker | |
| | The provision is necessary | AsciiArtChecker | |
| | because assistive technology | AppletChecker | |
| | cannot describe pictures, but | | |
| | can convey the text | | |
| | information to the user. | | |
| B | Paragraph (b) provides that | SynchronizedMediaChecker | Review |
| | equivalent alternatives for any | | candidate |
| | multimedia presentation shall | | violations for |
| | be synchronized with the | | synchronized |
| | presentation. | | equivalent. |
| C | Paragraph (c) prohibits the use | ColorContrastChecker | Review page to |
| | of color as the single method | ColorOffChecker | determine |
| | for indicating important | | accessibility |
| | information on a web page. | | without color. |
| D | Paragraph (d) provides that | StyleChecker | Review |
| | documents must be organized | | candidate |
| | so they are readable without | | violations to |
| | requiring browser support for | | determine |
| | style sheets. | | accessibility with |
| | | | stylesheets |
| | | | removed. |
| E | Paragraph (e) requires web | ImageMapChecker | No Manual |
| | page designers to include | SSIMAPChecker | Review Required |
| | redundant text links for each | | |
| | active region of a server-side | | |
| | image map on their web pages. | | |
| F | Paragraph (f) provides that | ImageMapChecker | No Manual |
| | client-side image maps shall be | | Review Required |
| | provided instead of server-side | | |
| | image maps except where the | | |
| | regions cannot be defined with | | |
| | an available geometric shape. | | |
| G & H | Paragraphs (g) and (h) permit | TableChecker | No Manual |
| | the use of tables, but require | | Review Required |
| | that the tables be coded | | |
| | according to the rules for | | |
| | developing tables of the | | |
| | markup language used. | | |
| I | Paragraph (i) addresses the use | FrameChecker | No Manual |
| | of frames and requires that | FrameTextChecker | Review Required |
| | they be titled with text to | | |
| | identify the frame and assist in | | |
| | navigating the frames. | | |
| J | Paragraph (j) sets limits on the | BlinkChecker | No Manual |
| | blink or flicker rate of screen | CSSChecker | Review Required |
| | elements. | | |
| K | Paragraph (k) requires that a | None | No Manual |
| | text-only web page shall only | | Review Required |
| | be provided as a last resort | | |
| | method for bringing a web site | | |
| | into compliance with the other | | |
| | requirements in § 1194.22. | | |
| L | Paragraph (l) requires that | NoScriptChecker | If site uses heavy |
| | when web pages rely on | AnchorChecker | javascript, ensure |
| | special programming | | it is readable |
| | instructions called “scripts” to | | with assistive |
| | affect information displayed or | | technology. |
| | to process user input, | | |
| | functional text shall be | | |
| | provided. Should have textual | | |
| | alternative. | | |
| M | This provision requires that | PlugInChecker | No Manual |
| | web pages which provide | | Review Required |
| | content such as Real Audio or | | |
| | PDF files, also provide a link | | |
| | to a plug-in that will meet the | | |
| | software provisions. | | |
| N | Paragraph (n) requires that | FormChecker | No Manual |
| | people with disabilities have | | Review Required |
| | access to interactive electronic | | |
| | forms. | | |
| O | Paragraph (o) provides that a | LinkSkipChecker | No Manual |
| | method be used to facilitate the | | Review Required |
| | easy tracking of page content | | |
| | that provides users of assistive | | |
| | technology the option to skip | | |
| | repetitive navigation links. | | |
| P | Paragraph (p) addresses the | TimeOutChecker | Review |
| | accessibility problems that can | | candidate |
| | occur if a web page times-out | | violations for |
| | while a user is completing a | | potential time- |
| | form. Web pages can be | | based responses. |
| | designed with scripts so that | | |
| | the web page disappears or | | |
| | “expires” if a response is not | | |
| | received within a specified | | |
| | amount of time. | | |

TABLE I(b)
Checker Functionality

| 36 CFR § | | |
|---|---|---|
| 1194.22 | | |
| Paragraph | Checker | Functionality |
| A | ImageChecker | Checks that images have valid alt attributes. |
| | | Checks that image links have valid alt attributes. |
| | | Checks that image buttons have valid alt |
| | | attributes. |
| | | Checks that long descriptions are valid. |
| | ObjectTextChecker | Checks that OBJECT elements have enclosed |
| | | textual descriptions. |
| | ImageMapChecker | Checks that AREAs have valid alt attributes. |
| | AppletChecker | Checks for valid textual alternatives in APPLET |
| | | elements. |
| B | SynchronizedMediaChecker | Diagnoses multimedia files as candidate |
| | | violations. Enabling “Manual Review” prompts |
| | | user to check that they are paired with accessible |
| | | alternatives. |
| C | ColorContrastChecker | Checks for sufficient color contrast between |
| | | foreground and background colors. |
| | ColorOffChecker | Diagnoses pages with color as candidate |
| | | violations. Enabling “Manual Review” prompts |
| | | user to check that a colorless version of the page |
| | | would be accessible. |
| D | StyleChecker | Diagnoses style sheet dependent elements as |
| | | candidate violations. Enabling “Manual Review” |
| | | prompts user to verify that the supplied previews |
| | | of elements without style sheets are accessible. |
| E | SSIMAPChecker | Diagnoses server-side image maps as candidate |
| | | violations. Enabling “Manual Review” prompts |
| | | user to check that textual alternatives are in place. |
| F | ImageMapChecker | Checks that all AREAs have valid alt attributes. |
| G & H | TableChecker | Checks that THEAD and TBODY are used |
| | | properly. |
| | | Checks that cells are properly associated with a |
| | | table header. |
| | | Checks that a table has either a caption element or |
| | | title attribute. |
| | | Checks that a table has a summary. |
| | | Checks that a table header has an “abbr” attribute |
| | | if the enclosed text is longer than one word. |
| | | Checks that a table defines the dir attribute. |
| I | FrameChecker | Checks that valid NOFRAMES elements are |
| | | used. |
| | FrameTextChecker | Checks that a FRAME has a valid title attribute. |
| J | BlinkChecker | Checks to see if BLINK/MARQUEE elements |
| | | are used. |
| | CSSChecker | Checks to see if BLINK/MARQUEE css |
| | | attributes are used. |
| L | NOSCRIPTChecker | Checks that valid NOSCRIPT elements are used. |
| | AnchorChecker | Checks that links do not directly target javascript. |
| M | PlugInChecker | Checks that all embedded files have links to |
| | | download plug-in. |
| N | FormChecker | Checks that OPTIONS are grouped by |
| | | OPTGROUP tags. |
| | | Checks that no form controls are missing labels. |
| | | Checks that labels are positioned properly. |
| | | Checks that labels are explicitly associated with |
| | | form controls. |
| | | Checks that FORMs are associated with |
| | | FIELDSET groups. |
| | | Checks that a FIELDSET group contains a |
| | | LEGEND. |
| | | Checks that one OPTION form control is selected |
| | | by default. |
| O | LinkSkipChecker | Checks that repetitive navigation links can be |
| | | skipped. |
| P | TimeOutChecker | Diagnoses a time-out page containing a form as a |
| | | candidate violation. Enabling “Manual Review” |
| | | prompts user to verify that time-out may be |
| | | turned off. |

TABLE II(a)
36 CFR § 1194.22 Fixers

| 36 CFR § | | | |
|---|---|---|---|
| 1194.22 | | | |
| Paragraph | Description | Fixers | Manual Fixes |
| A | Paragraph (a) requires that a text | ImageFixer | None |
| | equivalent for every non-text | ObjectTextFixer | |
| | element shall be provided. The | ImageMapFixer | |
| | provision is necessary because | AsciiArtFixer | |
| | assistive technology cannot describe | AppletFixer | |
| | pictures, but can convey the text | | |
| | information to the user. This | | |
| | provision requires that whenever an | | |
| | image is used an appropriate alt | | |
| | attribute must be defined. | | |
| B | Paragraph (b) provides that | n/a | Add equivalent |
| | equivalent alternatives for any | | alternatives for |
| | multimedia presentation shall be | | any multimedia |
| | synchronized with the presentation. | | presentation. |
| C | Paragraph (c) prohibits the use of | ColorContrastFixer | Add alternatives |
| | color as the single method for | | for any |
| | indicating important information on | | information that |
| | a web page. | | requires color. |
| D | Paragraph (d) provides that | n/a | Ensure that style |
| | documents must be organized so | | sheets are not |
| | they are readable without requiring | | required for |
| | browser support for style sheets. | | functionality. |
| E | Paragraph (e) requires web page | ImageMapFixer | If a server-side |
| | designers to include redundant text | | image map is |
| | links for each active region of a | | used, insert |
| | server-side image map on their web | | links with |
| | pages. | | textual |
| | | | alternatives into |
| | | | page. |
| F | Paragraph (f) provides that client- | ImageMapFixer | None |
| | side image maps shall be provided | | |
| | instead of server-side image maps | | |
| | except where the regions cannot be | | |
| | defined with an available geometric | | |
| | shape. | | |
| G & H | Paragraphs (g) and (h) permit the | TableFixer | None |
| | use of tables, but require that the | | |
| | tables be coded according to the | | |
| | rules for developing tables of the | | |
| | markup language used. | | |
| I | Paragraph (i) addresses the use of | FrameFixer | None |
| | frames and requires that they be | FrameTextFixer | |
| | titled with text to identify the frame | | |
| | and assist in navigating the frames. | | |
| J | Paragraph (j) sets limits on the blink | BlinkFixer | None |
| | or flicker rate of screen elements. | CSSFixer | |
| K | Paragraph (k) requires that a text- | n/a | None |
| | only web page shall only be | | |
| | provided as a last resort method for | | |
| | bringing a web site into compliance | | |
| | with the other requirements in | | |
| | §1194.22. | | |
| L | Paragraph (l) requires that when web | NoScriptFixer | If page cannot |
| | pages rely on special programming | AnchorFixer | be used without |
| | instructions called “scripts” to affect | ManualScriptFixer | scripts, create |
| | information displayed or to process | | alternate page. |
| | user input, functional text shall be | | |
| | provided. Should have textual | | |
| | alternative. | | |
| M | This provision requires that web | PluginFixer | None |
| | pages which provide content such as | | |
| | Real Audio or PDF files, also | | |
| | provide a link to a plug-in that will | | |
| | meet the software provisions. | | |
| N | Paragraph (n) requires that people | FormFixer | None |
| | with disabilities have access to | | |
| | interactive electronic forms. | | |
| O | Paragraph (o) provides that a method | LinkGroupFixer | None |
| | be used to facilitate the easy tracking | | |
| | of page content that provides users | | |
| | of assistive technology the option to | | |
| | skip repetitive navigation links. | | |
| P | Paragraph (p) addresses the | MetaRefreshFixer | None |
| | accessibility problems that can occur | | |
| | if a web page times-out while a user | | |
| | is completing a form. Web pages can | | |
| | be designed with scripts so that the | | |
| | web page disappears or “expires” if | | |
| | a response is not received within a | | |
| | specified amount of time. | | |

TABLE II(b)
Fixer Functionality

| 36 CFR § | | |
|---|---|---|
| 1194.22 | | |
| Paragraph | Fixer | Functionality |
| A | ImageFixer | Adds alt attributes to images |
| | | Adds alt attributes to image buttons |
| | | Adds alt attributes to image links |
| | | Replaces alt attributes that are too long with shorter ones |
| | | Replaces vague alt attributes on images with more |
| | | meaningful ones |
| | | Replaces empty or invalid longdesc descriptions with valid |
| | | ones |
| | | Replaces vague alt attributes on image buttons with more |
| | | meaningful ones |
| | ObjectTextFixer | Adds a valid textual description to OBJECT elements |
| | AppletFixer | Adds textual alternatives to APPLET elements |
| C | ColorContrastFixer | Allows developer to select a new color which has sufficient |
| | | color contrast |
| F | ImageMapFixer | Adds alt attributes to AREAs |
| | | Replaces vague alt attributes in AREAs with more |
| | | meaningful ones |
| G & H | TableFixer | Inserts a caption element or title attribute to a table |
| | | Enters a single word abbreviation for a table header |
| | | Enters a dir attribute for a table |
| | | Associates cells with a table header |
| | | Enters a summary attribute for the table |
| I | FrameFixer | Adds a NOFRAMES tag to the page |
| | FrameTextFixer | Adds a valid title attribute to a FRAME |
| J | BlinkFixer | Replaces BLINK elements with other forms of emphasis |
| | CSSFixer | Replaces BLINK/MARQUEE CSS elements with other |
| | | forms of emphasis |
| L | NOSCRIPTFixer | Adds a NOSCRIPT element |
| | AnchorFixer | Modifies anchors so they do not directly target javascript |
| M | PlugInFixer | Adds a link to download identified media types |
| N | FormFixer | Adds OPTGROUP tags to element groups |
| | | Adds LABEL elements to forms |
| | | Explicitly associates a LABEL element with the form |
| | | control |
| | | Associates a FIELDSET grouping with a form |
| | | Adds a LEGEND to a FIELDSET |
| | | Adds a “selected” attribute to one OPTION element in each |
| | | SELECT form control |
| O | LinkSkipFixer | Adds inner-document links to group sets of related links |

Note that attributes listed in Tables I(a), I(b), II(a) and II(b) are key/value pairs that can be associated with an element in a tree. In HTML an example of an attribute would be the IMG element's alt attribute. (IMG is the HTML element that defines an image in a document). This alt attribute would be represented as alt=“descriptive text”. In this example alt is the attributes key, and descriptive text is the attributes value. An element, on the other hand, is a typed node that is a part of a document. An element's type communicates its function in the document. An element may have child elements as well as attributes.

The compliance retrofitter described above is used to build and maintain compliant HTML. It can be used to retrofit web sites by enabling automated and user-driven accessibility enhancements. It updates HTML code to make it compliant with 36 CFR § 1194.22.

The compliance retrofitter describes violations and offers recommended solutions. The compliance retrofitter enables customized tool selection to prioritize the desired retrofittings. The user may be presented with GUI's that are constantly updated to allow real time viewing of retrofitting effects.

The functionality of the compliance retrofitter may include customizable reports, current page reporting, enhanced “look and feel” and summary statistics. The algorithms of the compliance retrofitter may also include online “just-in-time” learning and diagnostic tolerances. Enhanced reporting may be included and may include summary reporting by total violations and violation type, page-by-page HTML reports, page-by-page spidering (building multiple pages by crawling through a publicly available website) and overall spidering speed increase.

### B. Link Skip Checker

As illustrated in Tables I(a) and I(b), the compliance retrofitter may include a link skip checker. The link skip checker checks for violations of paragraph (o) of § 1194.22, which provides: “A method shall be provided that permits users to skip repetitive navigation links.” The link skip checker implements an algorithm that finds logical groups of links in the document and flags them (i.e., specifies a particular HTML element as a violation) if there is no facility for skipping past the link group. For example, consider a web site that uses a top navigation bar on all its pages. Each time a user of an assistive technology that permits verbal communication of web content accesses a new page within the site, the user will have to listen to all the repetitive navigation bar links before accessing the content of the page. This makes it difficult to access information in an efficient manner. Therefore, to comply with § 1194.22 (o), it is important to include a mechanism allowing users to skip past groups of links. One way to accomplish this is through the use of inner-document links.

Link skip checker creates a psuedo-model of a document that represents the document as a series of text and links. This creates a model of a web page that looks something like: T L L L T L L T T, where T stands for a piece of text and L stands for a link. These items are further assigned lengths that represent the length of the text in the document. The length of the text (T) in the document is determined by measuring the length of the text based on the rules of HTML. The rules of HTML define certain space and character compressions that are applied to any piece of text. The application of the rule set at this point in the algorithm increases efficacy.

The link skip checker iterates over the psuedo-model of the document and divides the page into groups of links that are separated by a non-trivial length of text. For example, all text over the length of 20 may be considered to be non-trivial.

The link skip checker further divides each group based on the ancestral difference between adjacent links, where the ancestral difference is defined as the number of ancestor elements that are different between two elements in a document and an ancestor is an element located within the ancestor list for an element. For example, whenever adjacent links have an ancestral difference of more than 3 they may be considered to be in different link groups. For example, the ancestry (inclusive) of a P element may be HTML, BODY, P (paragraph) versus a TD (table data) element, which may have ancestry of HTML, BODY, TABLE, TR (table row), TD. In this example the ancestral difference between the P tag and the TD tag would be 4, thus placing them in different groups. The ancestral difference test allows a differentiation between link groups that, while not separated by much text, can be recognized by page positioning. This allows the differentiation of navigational features that are otherwise located close together in a page. As with length of non-trivial text, the allowable ancestral difference is customizable and may, by default, be set to 3.

Finally, the link skip checker checks for inner-document links within each link group that would allow a user to skip past the group of links. This check looks for a link in the early part of the group that is an inner-document link targeting a link late in the group. If no such link pairing is found, the link group is considered to be in violation of Section 508.

### C. Link Skip Fixer

As illustrated in Tables II(a) and II(b), the compliance retrofitter may include a link skip fixer. A link skip fixer inserts a link into the document of a web page that allows a user to skip past a particular group of links. The link skip fixer selects a candidate element from a page that can be used as a link without affecting the visual layout of the page. If no candidate element is found, the link skip fixer determines a nearby location that can house an image with minimal visual impact.

The link skip fixer algorithm looks at the HTML of a page and for a given link in the page, finds the nearest possible element that can be replaced with a skip link. The link skip fixer may determine a non-compliant link group by executing a link skip checker such as the link skip checker described above. The link skip fixer searches the elements near the front of the link group that can be used as surrogates for an anchor. These elements cannot be separated from the first link by any non-trivial amount of text, must have an ancestral difference of no more than specified amount with the first link in the group (where the value 3 may be the default specified amount, as describe in section B above); and cannot be either a blank piece of text or a blank image. If such a candidate is found then the link insertion will utilize the candidate's spot in the document and can make the fix without impacting the visual layout of the page. This fix has the same efficacy as other fixes but has the added benefit of causing zero impact on the visual layout of the page. If no such surrogate element can be found, the link skip fixer will utilize the default blank image defined in the configuration file of the program. This configuration allows the user to specify a default blank image that is utilized by the program to use as an element anchor for the link skip fixer.

The retrofitted, compliant link group may appear as follows: <A href=“#Top nav bar”><IMG src=“shim.gif” alt=“Skip Top nav bar link group” border=“0”></A>First Link . . . Last Link <A name=“Top nav bar”><IMG src=“shim.gif” alt=“End of Top nav bar link group” border=“0”></A>.

### D. Form Label Fixer

As illustrated in Tables II(a) and II(b), the compliance retrofitter may include a form label fixer. Paragraph (n) of 36 CFR § 1194.22 provides: “When electronic forms are designated to be completed on-line, the form shall allow people using assistive technology to access the information, field elements, and functionality required for completion and submission of the form, including all directions and cues.” Form fields are a way for users to enter input into a web page, usually by filling in text boxes or selecting from drop-down menus. Form fields are HTML elements that allow data entry into a form. A common form field is the INPUT element. This can be rendered as a checkbox, text entry, radio button, password field, or button. Other HTML elements exist for drop-downs, long text entries, etcetera. Form fields in violation of paragraph (n) are those form fields not explicitly associated with labels. In order to be accessible to people with disabilities, form fields must have either “label” attributes or LABEL elements that are explicitly associated with them. These labels enable users of assistive technologies to understand the type of input that must be entered into the form field.

A form label checker may be used to identify a form field in a document that does not have a label explicitly associated with it. A form label fixer may then be used to find a piece of text in the HTML page that is most likely the intended label for the form element. When inserting LABEL elements into a document, the form label fixer allows the user to select a LABEL element based on the nearest potential candidate element in the document. This allows the insertion of LABEL elements into a document utilizing elements that are already present in the document. The form label fixer identifies a nearby piece of text that is a candidate element for the form control label. This nearby element cannot be separated from the form control by any non-trivial elements, must not be a text element in any other form control; and must be no longer than a certain number of characters (for example 70). If such a textual element is found, the label will enclose the textual element in the appropriate markup and make the proper insertion into the document tree. This fixer then has no visual impact on the layout of the page.

Referring to FIG. 1, if a form control does not have a LABEL element properly associated with it, the HTML for the form control will be highlighted in the HTML window 40. The form label fixer may select the text elements in the page which are most likely to be the proper label for the form control (the “Intended Labels”). These text elements may be presented to the user in a window similar to description window 60, along with the message: “Please select the correct element or type in an appropriate label for the form control.” The window may provide the option of scrolling through “Intended Labels” or entering a “New Label.”

If one of the “Intended Label” fields is selected, the text inside the field will be rendered as a LABEL element explicitly associated with the currently highlighted element. This should not alter the appearance of the page in a browser (unless the text itself is altered). If “New Label” is selected, the form label fixer will insert a label element into the HTML of the page and explicitly associate it with the form field. If, for example, a Search field is highlighted, entering “Search” will cause a LABEL element to be inserted with the text “Search” and will cause the label to be explicitly associated with the form field. The explicit association is created using “id” and “for” elements. This is illustrated in the format: <LABEL for=“Email”> Email </LABEL><INPUT type=“text” name=“emailinput” size=“8” class=“NavBoldWhite” id=“Email”>. Users may find that the LABEL element produces secondary text on the page. If this negatively impacts the visual appearance of the page, users can eliminate the label that is not explicitly associated, and manipulate the newly inserted label to appear the same as the original label. To achieve this, a user may overwrite the original label with the newly inserted label. This will allow a user to maintain the visual appearance of the page and increase its accessibility to people with disabilities.

An intended label is determined by considering elements that meet the following criteria:

Must be a text element;

Must be a text element that would appear visually on the rendered page;

Cannot be a text element that is the child of one of the following (“a”, “applet”, “script”, “noscript”, “select”, “object”, “head”, “label”);

Must have a text length between 4 and 80 (4 and 80 being exemplary limits); and

Must have the BODY tag as an ancestor.

If during the course of this evaluation process any of the following occur;

The current element being evaluated does not have the BODY tag as an ancestor; or

The current element has no parent (is the root element), the algorithm will return that no candidate has been found. This is known as a break case. Otherwise if no candidate is found, and no break case was encountered, the form label fixer algorithm will search again at the subtree rooted up one ancestor (current parent's parent.) This will result in the search being performed recursively at the current form elements parent, then grandparent, then great-grandparent, etc., until a candidate is found or a break case in encountered. The algorithm will apply these criteria to all elements before and after the form field that requires a label. The elements in either direction, that satisfy this criteria first, are chosen as candidate elements. If, in either direction, a break case is encountered before a candidate is found no candidate is returned. Searching previous and subsequent elements from the form field ensures that the nearest candidate element is returned.

### E. Tolerances

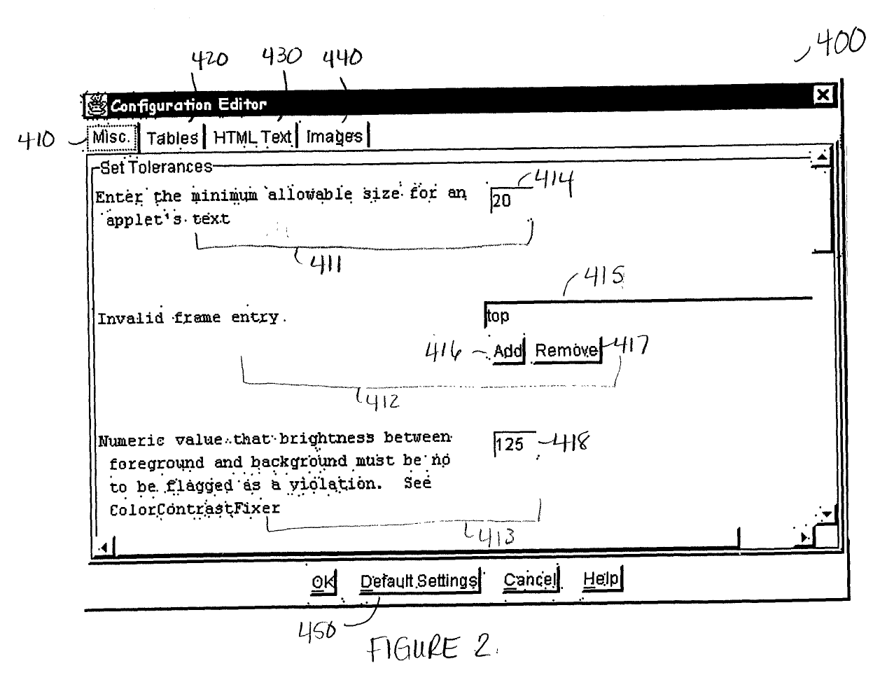

The compliance retrofitter may use a system of customizable parameters or “tolerances” to increase the accuracy of automated accessibility checking. “Tolerances” provide a high level approach to addressing Section 508 compliance that increases the accuracy of the checking process by allowing the user to configure the checking process. Tolerances are used to increase the accuracy of tests by decreasing the number of misdiagnoses and false positives, where misdiagnoses occur whenever a testing tool fails to mark a violating HTML element as a violation and false positives refer to an HTML element that is inaccurately marked as a violation. Tolerances can be edited to customize the tests for an individual website's look and feel. Tolerances are stored in an external XML file that is machine readable and can be edited by the user using a GUI, such as the GUI disclosed in FIG. 2. This feature allows the user to alter the configuration of the tools' tests and customize the tests for a particular client or website.

A detailed list of tolerances can be found in Table III.

TABLE III
Tolerances.

| Tolerance | Checker | Usage |
|---|---|---|
| Meaningless Alt | ImageChecker | Allows an editable list of meaningless |
| Attributes | | keywords to be checked against alt |
| | | attribute value |
| Minimum Alt Attribute | ImageChecker | Allows a user to edit to minimum length |
| Length | | for an alt attribute value to be meaningful |
| Meaningless Anchor Text | AnchorChecker | Allows a user to edit a list of meaningless |
| | | anchor text |
| Minimum Applet Text | AppletChecker | Allows a user to edit the minimum |
| Length | | allowable length of an APPLET |
| Image File Types | ImageChecker | Allows a user to edit the list of image file |
| | | types, aiding in the determination of alt |
| | | attribute meaningfulness |
| Meaningless Alt Length | ImageChecker | Allows the user to specify an alt attribute |
| | | length that implies meaning |
| Maximum Alt Length | ImageChecker | The longest allowable length of an alt tag |
| Brightness Difference | ColorContrastChecker | The minimum brightness difference |
| Minimum | | between two colors |
| Color Difference | ColorContrastChecker | The minimum allowable color difference |
| Minimum | | between two colors |
| Meaningless Frames Titles | FrameChecker | Allows and editable list of meaningless |
| | | keywords to be checked against frame |
| | | title attribute value |
| Max Link Inset | LinkSkipChecker | Allows a user to edit the maximum |
| | | allowable link inset |
| Minimum Characters | LinkSkipChecker | Allows a user to edit the minimum |
| Between Groups | | allowable text between links in a link |
| | | group |
| Minimum Number of | LinkSkipChecker | Allows a user to edit the minimum |
| links In Group | | number of links in a link group |
| Ancestor Difference | LinkSkipChecker | Allows a user to edit the maximum |
| | | ancestral difference for two proximate |
| | | links in a link group |
| NOFRAMES minimum | FrameTextChecker | Allows a user to edit the minimum |
| length | | allowable text length for a NOFRAMES |
| Ignore Input Types | FormChecker | Allows a user to edit a list of form input |
| | | types to ignore |
| Fieldset Size | FormChecker | Allows a user to edit the maximum |
| | | number of input fields allowed without a |
| | | fieldset |
| Optgroups Size | FormChecker | Allows a user to edit the maximum |
| | | number of options allowed without an |
| | | optgroup |
| Legend Size | FormChecker | Allows a user to edit the minimum |
| | | allowable text length for a LEGEND |
| Event Handler Pairs | EventHandlerChecker | Allows a user to edit a list of event |
| | | handlers |

Each of the checkers addressed in Table III is explained in more detail in Tables I(a) and I(b), above. For example, many websites will often use placeholders as the alt attributes for images on their sites. A common violation occurs when HTML authors have inserted meaningless alt attributes. The ImageChecker described in the first row of Table I(b) checks that images have valid alt attributes. But, a particular image may have the placeholder alt attribute: <img alt=“arrow” src=“arrow.gif”>. This image is not in violation of 36 CFR § 1194.22, Paragraph (a)—an alt attribute is present, it is just not meaningful. Therefore without tolerances the checker would fail to mark this image as a violation, resulting in a misdiagnosis. To decrease the number of misdiagnoses a tolerance “Meaningless Alt Attribute” may be provided to the user allowing an editable list of meaningless keywords to be checked against the alt attribute value. Table III (row 1). The user may edit the list “Meaningless Alt Attributes” and add the word “arrow” to the list. Doing so would cause the checker to flag this image as a violation, thus decreasing the number of misdiagnoses.

As another example, a common violation that occurs when using form elements on a page is the form element's lack of an explicitly associated label element. According to Section 508 all form elements must have a label associated with them that can be read out to assistive technologies. However form input elements, that resemble: <input type=“X” name=“firstname”>, will only need labels in certain instances. Based on the value of the type attribute a test can determine if the element needs to be tested for a form label. For example this input element would not need a label <input type=“hidden” name=“firstname”>while this input element would <input type=“text” name=“firstname”>. Tolerances allows a user to edit a list of “Ignore Input Types” and add the hidden type to the ignore list. This decreases the number of false positives by ignoring the appropriate input types.

A representative tolerances GUI editor is shown in FIG. 2 as configuration editor 400. The tolerances are divided up into categories and are addressed separately on the Misc. page 410, Tables page 420, HTML Text page 430 and Images Page 440. For example, tolerances relating to the link skip checker and to forms are selectable on the HTML Text page 430. Shown in FIG. 2, Misc. page 410 displays tolerances “Enter the minimum allowable size for an applet's text” 411 (with the default size based on 36 CFR § 1194.22, paragraph (a) of 20), “Invalid frame entry” 412 (with the default invalid frame title list 414 based in part on 36 CFR § 1194.22, paragraph (i), including “top”), and “Numeric value that brightness between foreground and background must be no[t] to be flagged as a violation” 413 (with the default setting based in part on 36 CFR § 1194.22, paragraph (c) of 125). The default settings are chosen in part to ensure compliance with the Section 508 standards.

A user may adjust the defaults either to increase the accuracy of the checkers, enforce the standards more aggressively or loosen the standards enforcement. This allows a user to modify or personalize his or her compliance retrofitter within the standard limits, or to override those limits. For example, a user may modify the minimum allowable size for an applet's text by editing the number in box 414, or may modify the numeric value that brightness between foreground and background must be by editing the number in box 418. Or, a user may add or remove items from a list of invalid frame titles by clicking on the add button 415 or remove button 417 and adding text to box 415. Tolerances may be presented to the user in any number of ways, as long as the interface allows a user to modify or select a tolerance. In the sample presented in FIG. 4, a user may also click on “Default Settings” button 450 to clear the user-selected tolerances and reset the tolerances to the default values.

A number of embodiments of the invention have been described. Nevertheless, it will be understood that various modifications may be made without departing from the spirit and scope of the invention. For example, the compliance retrofitter may include a development tool that performs the same checks as mentioned above, but also inserts the accessibility enhancements directly into the HTML code, where possible. If a fix requires manual re-coding by the developer, the compliance retrofitter facilitates this process by prompting the user within the application with examples of the necessary changes to be made. In this way, the compliance retrofitter inputs a web page that is not compliant with Section 508 and outputs one that is fully compliant.

The compliance retrofitter may be platform independent by using a platform independent language such as Java (Sun Micro Systems, Inc. of Palo Alto, Calif.), and can be run on any platform for which a Java Virtual Machine exists, including Windows 95/98, Windows 2000, Windows NT and Linux. The compliance retrofitter may be designed to interface with other web development tools such as FrontPage™ offered by Microsoft Corporation of Redmond, Wash., DreamWeaver™ offered by Macromedia, Inc. of San Francisco, Calif., and Adobe™ GoLive™ offered by Adobe Systems, Inc. of San Jose, Calif. The compliance retrofitter may retrofit dynamically generated pages. When used with dynamically-generated pages, the compliance retrofitter diagnoses, fixes and outputs what the code base should be generating. The compliance retrofitter can be used to fix static HTML during the creative design process before the templates are tied into the database. This will aid in the output of dynamic pages being compliant.

Although the invention has been described in relation to the currently-existing Section 508 web accessibility standards, it applies equally to compliance with any accessibility standards and will apply to any future versions of Section 508. Accordingly, other embodiments are within the scope of the following claims.

What is claimed is:

1. A method for checking an HTML document of a web page for compliance with Section 508 of the Rehabilitation Act of 1973, as amended, comprising:
running a checker against an HTML document;
flagging a violation of a requirement of Section 508; and
fixing a section of the HTML document containing the flagged violation by modifying HTML code.

2. The method of claim 1, comprising:
providing a user interface operable to:
display information about the flagged violation; and
query a user for input relating to the flagged violation;
receiving the user input; and
using the user input, fixing the section of the HTML document.

3. The method of claim 2, comprising offering a recommended solution to the user.

4. The method of claim 2, comprising using previously-saved user input saved at the user's request to fix the section of the HTML document.

5. The method of claim 1, wherein fixing the section of the HTML document containing the flagged violation is accomplished without input from a user.

6. The method of claim 1, comprising providing a user interface operable to display information about the flagged violation and provide details as to how the violation may be manually cured.

7. The method of claim 1, comprising displaying the flagged violation on a user interface.

8. The method of claim 1, comprising:
providing a user interface operable to accept user input; and
using the user input, modifying tolerances of one or more checkers.

9. The method of claim 1, comprising:
locating logical groups of links in the document; and
determining whether there is a facility for skipping past a located, logical group of links.

10. The method of claim 9, locating logical groups of links in the document comprising:
producing a psuedo-model of the document that represents the document as a series of text and links;
dividing the pseudo-model into groups of links that are separated by a predetermined length of text; and
dividing each group of links based on ancestral differences between adjacent links.

11. The method of claim 9, determining whether there is a facility for skipping past a located, logical group of links comprising checking for inner-document links within each logical group of links that allow a user to skip past the logical group of links.

12. The method of claim 1, comprising inserting an inner-document link permitting a user to skip past a group of links.

13. The method of claim 1, comprising:
identifying a located, logical group of links for which there is no facility for skipping past;
searching elements near the front of the identified link group for a surrogate anchor element; and
inserting an inner-document link at the beginning of the link
group, where the inner-document link inserted at the beginning of the link group replaces the surrogate anchor element.

14. The method of claim 1, comprising:
identifying, for a form field not associated with a label, a piece of text that is a candidate for the label; and
associating the piece of text with the label.

15. The method of claim 14, identifying a piece of text that is a candidate for the label, comprising identifying a piece of text that:
is not a child of any of “a”, “applet”, “script”, “noscript”, “select”, “object”, “head”, or “label;” and
has a predetermined text length.

16. The method of claim 1, comprising:
identifying, for a form field not associated with a label, a piece of text that is a candidate for the label;
prompting a user to select the candidate label or insert a label; and
based on the user's selection, associating the piece of text with the candidate label or the inserted label.

17. A method for checking an HTML document, comprising:
using a computer program, locating logical groups of links in the document; and
using a computer program, determining whether there is a facility for skipping past a located, logical group of links.

18. The method of claim 17, locating logical groups of links in the document comprising:
producing a psuedo-model of the document that represents the document as a series of text and links;
dividing the pseudo-model into groups of links that are separated by a predetermined length of text; and
dividing each group of links based on ancestral differences between adjacent links.

19. The method of claim 17, determining whether there is a facility for skipping past a located, logical group of links comprising checking for inner-document links within the each logical group of links that allow a user to skip past the logical group of links.

20. A method for inserting an inner-document link permitting a user to skip past a group of links, comprising:
identifying a located, logical group of links for which there is no facility for skipping past;
searching elements near the front of the identified link group for a surrogate anchor element; and
inserting an inner-document link at the beginning of the link group, where the inner-document link inserted at the beginning of the link group replaces the surrogate anchor element.

21. The method of claim 20, searching elements near the front of the identified link group for a surrogate anchor element, comprising searching for a surrogate anchor element:
that can be used as an anchor;
is not separated from a first link by a predetermined amount of text;
has an ancestral difference of no more than a predetermined number with the first link; and
is not a blank piece of text or a blank image.

22. A method for fixing an HTML document, comprising
identifying, for a form field not associated with a label, a piece of text that is a candidate for the label; and
associating the piece of text with the label.

23. The method of claim 22, identifying a piece of text that is a candidate for the label, comprising identifying a piece of text that
is not a child of any of “a”, “applet”, “script”, “noscript”, “select”, “object”, “head”, or “label;” and
has a predetermined text length.

24. A method for fixing an HTML document, comprising
identifying, for a form field not associated with a label, a piece of text that is a candidate for the label;
prompting a user to select the candidate label or insert a label; and
based on the user's selection, associating the piece of text with the candidate label or the inserted label.

25. A method for checking an HTML document of a web page for accessibility, comprising:
providing a user interface operable to accept user input;
soliciting user input to modify tolerances of a checker;
running the checker against an HTML document;
flagging an accessibility violation; and
fixing a section of the HTML document containing the flagged violation by modifying HTML code.

26. A computer program product, tangibly embodied on a machine-readable medium, for checking an HTML document of a web page for compliance with Section 508 of the Rehabilitation Act of 1973, as amended, comprising instructions operable to cause a programmable processor to:
run a checker against an HTML document;
flag a violation of a requirement of Section 508; and
fix a section of the HTML document containing the flagged violation by modifying HTML code.

27. The method of claim 26, comprising instructions operable to cause a programmable processor to:
provide a user interface operable to:
display information about the flagged violation; and
query a user for input relating to the flagged violation;
receive the user input; and
using the user input, fix the section of the HTML document.

28. The method of claim 27, comprising instructions operable to cause a programmable processor to offer a recommended solution to the user.

29. The method of claim 27, comprising instructions operable to cause a programmable processor to use previously-saved user input saved at the user's request to fix the section of the HTML document.

30. The method of claim 26, comprising instructions operable to cause a programmable processor to fix the section of the HTML document containing the flagged violation without input from a user.

31. The method of claim 26, comprising instructions operable to cause a programmable processor to provide a user interface operable to display information about the flagged violation and provide details as to how the violation may be manually cured.

32. The method of claim 26, comprising instructions operable to cause a programmable processor to display the flagged violation on a user interface.

33. The method of claim 26, comprising instructions operable to cause a programmable processor to:
provide a user interface operable to accept user input; and
using the user input, modify tolerances of one or more checkers.

34. The method of claim 26, comprising instructions operable to cause a programmable processor to:
locate a logical group of links in the document; and
determine whether there is a facility for skipping past the located, logical group of links.

35. The method of claim 34, instructions for locating logical groups of links in the document operable to cause the programmable processor to:
produce a psuedo-model of the document that represents the document as a series of text and links;
divide the pseudo-model into groups of links that are separated by a predetermined length of text; and
divide each group based on ancestral differences between adjacent links.

36. The method of claim 34, instructions for determining whether there is a facility for skipping past a located, logical group of links operable to cause the programmable processor to check for inner-document links within each logical group of links that allow a user to skip past the logical group of links.

37. The method of claim 26, comprising instructions operable to cause a programmable processor to insert an inner-document link permitting a user to skip past a group of links.

38. The method of claim 26, comprising instructions operable to cause a programmable processor to:
identify a located, logical group of links for which there is no facility for skipping past;
search elements near the front of the identified link group for a surrogate anchor element; and
insert an inner-document link at the beginning of the link group, where the inner-document link inserted at the beginning of the link group replaces the surrogate anchor element.

39. The method of claim 26, comprising instructions operable to cause a programmable processor to:
identify, for a form field not associated with a label, a piece of text that is a candidate for the label; and
associate the piece of text with the label.

40. The method of claim 39, instructions for identifying a piece of text that is a candidate for the label, comprising instructions operable to cause the programmable processor to identify a piece of text that:
is not a child of any of “a”, “applet”, “script”, “noscript”, “select”, “object”, “head”, or “label;” and
has a predetermined text length.

41. The method of claim 26, comprising instructions operable to cause a programmable processor to:
identify, for a form field not associated with a label, a piece of text that is a candidate for the label;
prompt a user to select the candidate label or insert a label; and
based on the user's selection, associate the piece of text with the candidate label or the inserted label.

42. A computer program product, tangibly embodied on a machine-readable medium, for checking an HTML document, comprising instructions operable to cause a programmable processor to:
locate a logical group of links in the document; and
determine whether there is a facility for skipping past the located, logical group of links.

43. The method of claim 42, instructions for locating logical groups of links in the document operable to cause a programmable processor to:
produce a psuedo-model of the document that represents the document as a series of text and links;
divide the pseudo-model into groups of links that are separated by a predetermined length of text; and
divide each group based on ancestral differences between adjacent links.

44. The method of claim 42, instructions for determining whether there is a facility for skipping past a located, logical group of links operable to cause a programmable processor to check for inner-document links within the each logical group of links that allow a user to skip past the logical group of links.

45. A computer program product, tangibly embodied on a machine-readable medium, for inserting an inner-document link permitting a user to skip past a group of links, comprising instructions operable to cause a programmable processor to:
identify a located, logical group of links for which there is no facility for skipping past;
search elements near the front of the identified link group for a surrogate anchor element; and
insert an inner-document link at the beginning of the link group, where the inner-document link inserted at the beginning of the link group replaces the surrogate anchor element.

46. The method of claim 45, instructions for searching elements near the front of the identified link group for a surrogate anchor element, comprising instructions operable to cause a programmable processor to search for a surrogate anchor element that:
can be used as an anchor,
is not separated from a first link by a predetermined amount of text;
has an ancestral difference of no more than a predetermined number with the first link; and
is not a blank piece of text or a blank image.

47. A computer program product, tangibly embodied on a machine-readable medium, for fixing an HTML document, comprising instructions operable to cause a programmable processor to:
identify, for a form field not associated with a label, a piece of text that is a candidate for the label; and
associating the piece of text with the label.

48. The method of claim 47, instructions for identifying a piece of text that is a candidate for the label comprising instructions operable to cause a programmable processor to identify a piece of text that:
is not a child of any of “a”, “applet”, “script”, “noscript”, “select”, “object”, “head”, or “label;” and
has a predetermined text length.

49. A computer program product, tangibly embodied on a machine-readable medium, for fixing an HTML document, comprising instructions operable to cause a programmable processor to:
identify, for a form field not associated with a label, a piece of text that is a candidate for the label;
prompt a user to select the candidate label or insert a label;
based on the user's selection, associate the piece of text with the candidate label or the inserted label.

50. A computer program product, tangibly embodied on a machine-readable medium, for checking an HTML document of a web page for accessibility, comprising instructions operable to cause a programmable processor to:
provide a user interface operable to accept user input;
solicit user input to modify tolerances of a checker;
run the checker against an HTML document;
flag an accessibility violation; and
fix a section of the HTML document containing the flagged violation by modifying HTML code.
